(19) United States
(12) Patent Application Publication
(10) Pub. No.: US 2004/0016442 A1
(43) Pub. Date: Jan. 29, 2004

(54) Megasonically energized liquid interface apparatus and method

(76) Inventor: B. Gene Cawlfield, Dallas, TX (US)

Correspondence Address: THE LAW OFFICES OF H. DENNIS KELLY, 2401 TURTLE CREEK, DALLAS, TX, 75219, US

(21) Appl. No.: 10/064,571

(22) Filed: Jul. 26, 2002

(51) Int. Cl. B08B 3/12

(52) U.S. Cl. 134/1.3; 134/30; 134/186; 134/102.1; 134/902

(57) ABSTRACT

Apparatus and method for removing material adhering to a workpiece are disclosed. A process liquid and a discontinuous phase are placed in a process tank adapted to receive a workpiece. The interface between the process liquid and the discontinuous phase is energized with megasonic energy, and the interface is contacted with and moved relative to the workpiece in a linear direction at a controlled rate, preferably across all of the workpiece. Liquid in the interface is optionally removed from the process tank at predetermined times to remove entrained particles. Numerous drying schemes can be used to reduce or eliminate formation of droplets and to speed drying time.

### BACKGROUND OF INVENTION

This invention relates in general to apparatus and processes using megasonic energy. In particular, the invention relates to a wet process for removing material adhering to a workpiece surface by repeated exposure of the workpiece surface to the interface between a liquid and a discontinuous phase while the interface is excited by megasonic energy.

Advances in semiconductor manufacturing have resulted in ever shrinking geometries, which have demanded a corresponding increase in cleanliness for equipment, photomasks and wafers to prevent unacceptable defect levels. A particle one fourth the size of a pattern width is considered unacceptable. Present geometries already force visible light microscopes to struggle in order to provide practical inspection and description of all small particles of concern. One of the more recent photolithographic methods, known as phase shift photomask, can even create pattern geometry smaller than a wavelength of the ultraviolet light used to expose the pattern. This lowers the allowable particle size to a level that present cleaning methods either have trouble achieving, or fail to achieve altogether.

Methods for cleaning photomasks and wafers must dislodge and move increasingly smaller particles away from the workpiece surface, through the boundary layer of the liquid flowing across the workpiece surface. The effect of gravity on such microscopically small particles is insignificant compared to such effects as Van der Waal's force and surface and interfacial tensions, which tend to force the particles back onto the workpiece surface, especially in the meniscus. These forces must be overcome or they tend to redeposit particles back onto the cleaned surface.

A method that has been in use for over a decade is disclosed in U.S. Pat. No. 4,778,532, issued to McConnell et al. This cleaning method and the associated apparatus make use of the Marangoni effect to clean semiconductor wafers. The fact that this method is still in use after so many years is a testament to its ability to remove particles. However, McConnell admits in an article entitled “Examining the Effects of Wafer Surface Chemistry on Particle Removal Using Direct-Displacement Isopropyl Alcohol Drying” that the method reaches a particle pseudo-equilibrium, wherein the total number of particles found on the wafer remains constant with further cleaning cycles, although the actual locations of the particles on the disk will vary from cycle to cycle. Isopropyl alcohol (IPA) is used to displace water at the wafer surface in an attempt to alter the surface chemistry dynamics for improved particle removal, but the pseudo-equilibrium effect remains to a lesser degree, and the use of IPA is a drawback due to IPA's environmental and fire hazards. In addition, the equipment is complex and expensive to construct and operate, and the time required to clean each wafer is longer than that in most methods.

Both ultrasonic (20,000 to several hundred thousand cycles per second) and megasonic (about 700,000 to tens of million cycles per second) sonic energy have been widely used for cleaning various objects, from jewelry to processed semiconductor wafers. The generally accepted explanation as to how these methods work is that local low pressure points in the sonic energy field cause cavitation bubbles to form in a liquid, which then collapse causing shock waves that dislodge and remove particles from the surface of the workpiece. These processes therefore must use a liquid medium.

One cleaning method using megasonic energy that has found acceptance is known as the “Goldfinger” method. An example of this method is disclosed in U.S. Pat. No. 6,295,999, issued to Bran. This method requires complex apparatus with many more parts than competing methods, and is much more expensive to construct and to operate. Also, this method only cleans one side of the wafer at a time, and cannot be easily adapted to handle multiple wafers at a single time, resulting in very low throughput compared to other methods. This method obviously cannot be adapted to cleaning non-flat workpieces, that is, those with significant variations in surface height.

U.S. Pat. No. 6,378,534, issued to Olesen et al. discloses another process and apparatus using megasonic energy for cleaning a batch of semiconductor wafers. The wafers are exposed to a number of liquid chemical agents in separate treatment cycles. Most of these cycles end in a series of fill/rinse steps separated by interposing “quick dump” steps. The wafers are sprayed with DI water throughout each dump-and-rinse cycle, and large spray droplets are preferred over mist. This process is satisfactory at reducing submicron particle count on cleaned workpieces at present, and may be adequate for the near future. However, the particle count could be significantly reduced, and the process has high liquid consumption rates relative to other processes. Finally, while the dump steps occur quickly, the fill steps take considerably more time, typically about twenty seconds, so that the total time for performing the series of fill/dump step pairs is long and throughput suffers accordingly.

The Olesen et al. disclosure reflects the conventional wisdom that the advantages of megasonic energy are obtained when the wafers are immersed in the energized liquid. No prior art to the inventor's knowledge recognizes the advantages of using the megasonically energized liquid interface for material removal. While the energized liquid interface is accidently applied to the workpiece in several prior art methods, in most cases it is only for a single sweep occurring when energized liquid is drained off the work piece following complete immersion. The method disclosed in the Olesen et al. reference unintentionally makes better use of the energized liquid interface by applying it during each of the dump-and-rinse cycles. The result is far from however. In fact, several features in the Olesen et al. method and apparatus result in irregular, nonuniform and nonrepeatable exposure of the energized liquid interface to the workpiece surfaces. The bottom of the wafers are located in a section of the tank having walls that taper sharply inwards toward the transducer, which is located directly below the wafers. Filling the tank at a constant flow rate means that the liquid interface rises more quickly in this area than it does in the upper section of the tank, where the walls are parallel. A similar abrupt change in interface velocity will occur when dumping the tank contents. The transducer's location in the tank creates two narrow channels just below the wafers. These channels create jet-like turbulence that bounces the liquid interface during the beginning of filling; similar surface disturbance occur during the “quick dump”. When this effect is considered along with the nonuniform interface velocity, it becomes clear that there is a significant and random variation in the total time that individual locations on the wafer surface are exposed to the energized liquid interface, and a similar random variation in the intensity of the megasonic energy field across the area of contact with the workpiece. In addition, the use of spray during the quick dump step unnecessarily creates a risk of droplet formation on the wafer surface, especially when droplet spray is used, since most of the spray will fall on the withdrawn wafer surface where there is no megasonic energy to help prevent droplet formation. If spray intensity is high enough, when the spray strikes the liquid surface it may even splash cleaning liquid having entrained particles up onto the just cleaned wafer surface. Obviously, use of spray will make the liquid interface rough and erratic, like rain on a puddle.

The inventor has been granted U.S. Pat. No. 5,246,025 (the '025 patent), incorporated herein by reference, for a cleaning apparatus using gas pressure to repeatedly and rapidly raise and lower a process liquid past a work piece. A minor variation in operation of this apparatus yields several features and results that are desirable for use with the current invention.

A need remains for an apparatus and method that can remove particles present during processing of semiconductor wafers and photomasks, with lower remaining particle counts than known methods and apparatus. An apparatus and method that can process multiple wafers at one time in less time than conventional methods is also desired. A method that can be performed without the need for flammable and corrosive chemicals, or chemicals that present environmental or health risks is also desired. As always, an apparatus that is less expensive to construct and operate is also desired.

### SUMMARY OF INVENTION

The various embodiments of the invention all utilize a previously unrecognized phenomenon: when a body of liquid contacts a separate discontinuous phase and the liquid is bombarded with megasonic energy, the intensity of megasonic energy at the interface between the liquid and the discontinuous phase is much greater than that in the bulk liquid itself. One possible explanation is that only a minor portion of the megasonic energy is reflected from or transmitted through the interface, leaving the remainder of the energy to be absorbed by the liquid (and any dispersed particles) in the interfacial region. The greater megasonic intensity will dislodge and remove particles from a workpiece surface so rapidly that sweeping the workpiece surface with the interface actually gives quicker results than immersing the workpiece continuously in the energized liquid. Also, the high-intensity sonic energy field in the region of the liquid interface appears to energize the particles in the liquid enough to overcome the molecular forces acting to adhere the particles to the workpiece surface. Why this occurs is not clearly understood, although the affects on particle removal are indisputable. The discontinuous phase can be a gas, another liquid immiscible with the energized liquid, a gel, sol, foam, fog or other homogeneous phase, as long as an interface having the necessary sonic field intensity is present. When three or more phases are present with at least two of them being liquid, it is possible to have more than one megasonically energized interface

In general, a structure for achieving the desired features and advantages has a process tank adapted to receive the workpiece, a process liquid and a discontinuous phase that forms an interface with the process liquid; means for energizing the liquid interface with megasonic energy; and means for sweeping the energized liquid interface across the workpiece at a controlled rate, preferably by moving the process liquid into and out of the process tank. The preferred means for moving the process liquid into and out of the process tank is a home container connected to the process tank in combination with connections on one or both of the home container and the process tank that connect to positive pressure/vacuum sources for varying the pressures in the vessels. Other means for moving the liquid are disclosed in the '025 patent. Optional elements include means for removing a portion of the process liquid as an overflow liquid, means for discarding all or part of the overflow liquid in combination with means for replacing the discarded overflow liquid with fresh process liquid, means for using megasonic energy to propel entrained particles into the overflow liquid, a recirculating system for processing overflow liquid and returning it to the home container, means for independently moving a number of separate process liquids into and out of the process tank, and automatic control means for performing the method of the invention.

In an alternative apparatus embodiment, either or both of the process tank and the home container has means for sealing the interior of the vessel in a gas-tight relation to the environment. The sealed vessel(s) can be connected to a source of variable vacuum or variable low pressure gas or both so as to move the liquid between the process tank and the home container in a manner similar to that disclosed in the '025 patent. Preferably, nitrogen made from air liquification is preferred because of its high purity and lack of entrained particles.

A method for achieving the desired features and advantages comprises the steps of energizing a liquid interface with megasonic energy, and moving the megasonically energized liquid interface across the workpiece at a controlled rate. This sweep is repeated a predetermined number of times, during which time the workpiece is entirely immersed in and then entirely removed from the liquid, so that the direction of movement alternates between sweeps. Five pairs of up and down sweeps are preferred for use with semiconductor photomasks. The liquid interface sweep velocity is preferably in the range of about 0.5 inch/sec to about 20 inch/sec (about 13 mm/sec to 508 mm/sec), and more preferably in the range of about one inch/sec to about twelve inch/second (about 25 mm/sec to 305 mm/sec). The interface preferably remains fully energized between successive sweeps. The workpiece is removed from the liquid in the final sweep step and dried, preferably using one of several schemes that will be discussed below. The same method can be repeated for a number of different process liquids applied in sequence.

An alternative method embodiment is envisioned wherein the megasonically energized interface is used to remove photoresist. In this embodiment ozone is introduced to the liquid, preferably by bubbling the ozone through the liquid in the home container or the process tank. Ozone can optionally be added to the atmosphere in the process tank. The rest of the method is substantially the same as the general method embodiment.

Several drying schemes are preferred for use with the method of the invention. All of the drying schemes are directed primarily to preventing formation of droplets on the workpiece as it is separated from the process fluid, since the method substantially eliminates any need for the drying step to remove particles or prevent their redeposition on the workpiece. In one drying scheme, deionized (DI) water or dilute Standard Clean 1 (SC-1) is used as the process liquid, and the liquid temperature is controlled at a value of between about thirty to ninety degrees Celsius to promote rapid drying of the workpiece following the final withdrawal of the workpiece from the process liquid. Preferably a dry atmosphere such as nitrogen is used to reduce drying time. In a second drying scheme, a second chemical such as IPA at a higher temperature than the process liquid can be applied to the workpiece to improve drying. The IPA can be applied as a vapor that condenses on the workpiece or it can be applied directly as a mist. The process fluid and the IPA are vigorously mixed at the megasonically energized interface. The resulting mixture wets the workpiece more effectively, which reduces or even prevents formation of water droplets on the workpiece, which are undesirable since they can leave water spots from dissolved solids. The IPA is not used (or needed) to displace the process liquid at the meniscus in order to prevent particles in the process liquid from adhering to the workpiece surface, unlike the McConnell et al. method. Other liquids can be substituted for IPA.

A third drying scheme is envisioned for use with the method embodiments, wherein the process liquid is Dl water at a temperature between 3 to 10 degrees Celsius, and the discontinuous phase is a gas (preferably from a dry source) at between 10 to 25 degrees Celsius below the water freezing point temperature. Thus, the liquid contacting the discontinuous phase would freeze if the megasonic energy were not present. Then, the water wetting the wafer's surface during withdrawal freezes rather than evaporating, creating a thin layer of ice on the surface of the wafer. The remaining liquid is removed, and system pressure is then reduced until the ice sublimes.

A fourth drying scheme can also be used, wherein the process tank is gas-tight and pressurized between about 30 and 100 psig, preferably with carbon dioxide, and carbon dioxide is bubbled into the process liquid which is preferably DI water. Carbonated DI water has improved wetting properties over uncarbonated DI water, in particular the surface and interfacial tensions are so compatible with processed silicon that the liquid film formed during withdrawal of the workpiece from the megasonically energized process liquid is thinner and has less tendency to form droplets on the workpiece surface. Warm carbon dioxide is then blown into the process tank while maintaining pressure until the workpiece is dry.

Particle removal using the megasonically energized liquid interface is so effective that ALL particles above about 0.25 micron in size are typically removed, i.e. ZERO particles remain. This result was unexpected and is a dramatic improvement over existing methods. Testing was conducted on a six-inch photomask to establish that the megasonically energized liquid interface is essentially responsible for this dramatic and unexpected result, regardless of the time the workpiece spends immersed in the bulk liquid. If exposure to megasonic energy in the bulk liquid (i.e. being immersed) makes a significant contribution to particle removal, then it would be expected that areas of the workpiece that are immersed the longest (i.e. at or near the bottom) would also show the greatest percentage reduction in particle count. For testing purposes, only four sweeps were performed, so that a sufficient number of particles would be left on the wafer. Testing revealed a substantially uniform reduction in particle count across the wafer face; there was no apparent change in particle count reduction with height. This confirms the assumption that immersion of the workpiece has a negligible effect in comparison to exposure of the workpiece to the megasonically energized liquid interface.

The apparatus and method of the invention have numerous advantages and provide numerous improvements over existing apparatuses and methods. The method completely removes all particles down to about 0.25 micron in size, and future testing is expected to confirm similar performance for particles down to about 0.15 micron in size. The smallest particle size for which zero particle residue can be obtained is not known, but it is expected to be small enough for the next few generations of size reduction. Test runs on semiconductor photomasks reached zero particle count after only thirty seconds of particle removal processing, which is significantly shorter than known methods, thereby allowing more wafers to be processed per hour. The apparatus is simple and inexpensive to construct and operate. The megasonic energy is more uniformly distributed across the interface than in the bulk liquid, and shadowing problems present in conventional immersion methods are largely avoided. The method lends itself more readily to the use of environmentally non-hazardous liquids while still achieving desired particle and film removal. The method can remove all manner of material adhering to the workpiece surface, and is therefore capable of being used throughout semiconductor manufacturing, for developing, etching, photoresist stripping, rinsing and post chemical-mechanical polish (CMP) cleaning as well as conventional cleaning. In fact, the method and apparatus can also be used in applications outside of semiconductor manufacturing, such as degreasing and cleaning of machined articles from conventional milling machinery. Additional features and advantages of the invention will become apparent in the following detailed description and in the drawings.

### BRIEF DESCRIPTION OF DRAWINGS

FIG. 1 is a partially cross-sectional schematic view of a general embodiment of the invention.

FIG. 2 is a partially cross-sectional schematic view of an alternative apparatus for practicing the method of the invention, employing a different arrangement for generating and directing the megasonic energy.

FIGS. 3 and 4 are partially cross-sectional schematic views of two arrangements using the megasonic energy to sweep particles at the interface out of the process tank.

FIG. 5 is a partially cross-sectional schematic view of an alternative apparatus having a gas-tight process tank.

FIG. 6 is a partially cross-sectional schematic view of apparatus including a preferred home container, showing the apparatus details between the process tank and the home container.

FIG. 7 is a schematic detail of the preferred apparatus for connecting positive pressure or vacuum to a gas-tight vessel.

FIG. 8 is a schematic view of preferred liquid levels in the process tank while carrying out a method of the invention.

FIG. 9 is a partially cross-sectional schematic view of an alternative apparatus.

### DETAILED DESCRIPTION

The drawings are intended to illustrate the functional interrelationships of the various structural elements, and should not be taken as representing any exact arrangement of equipment, except where expressly noted. In the following discussion, elements performing the same function throughout various figures are referenced by the same numbers in the figures. Unless specifically limited to a particular embodiment or embodiments, elements and features of a particular embodiment shown in a figure can be used in any of the other embodiments.

Terms used throughout this specification and in the claims have the following definitions: the term “liquid interface” is defined as liquid at or near the interface between the process liquid and a discontinuous phase contiguous with the process liquid; the term “at a controlled rate” means at such speed and under such conditions that the energized liquid interface has a stable and repeatable shape when in contact with the workpiece. The term “discontinuous phase” is defined as a fluid phase that is substantially immiscible with the process liquid, i.e. the discontinuous phase does not mix with the process liquid, except for gas absorption into the process liquid. Although forced emulsification of the two phases can occur at the energized interface, the process liquid and the discontinuous phase will separate back out into readily distinguished phases when the megasonic energy is removed.

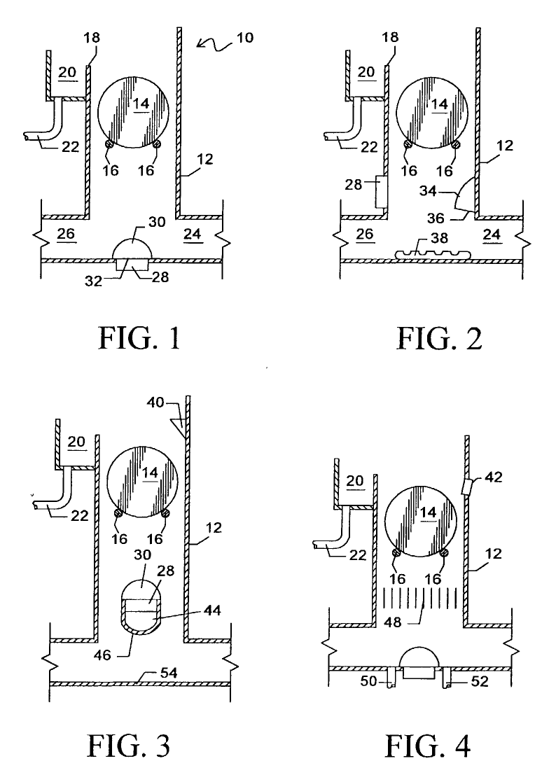

An apparatus 10 for performing the general method of the invention is shown in FIG. 1. The apparatus 10 includes a process tank 12 for holding a workpiece, typically a semiconductor wafer 14 supported in a rack 16, tray, cassette or other device commonly used in the industry. One side of the tank forms an overflow weir 18. An overflow tank 20 attaches to the process tank 12 beneath the overflow weir 18 and receives overflow liquid from the process tank 12. A circulation line 22 connects to the overflow tank 20 and connects to further equipment to be discussed later. The bottom of the process tank 12 has connections 24 and 26 (optional) providing the means for allowing two separate process liquids to flow into and out of the process tank 12 from individual home containers (not shown), depending on the particular process. More connections can be added for even more process liquids as desired.

A process transducer 28 and integrated lens 30 are mounted in the bottom of the process tank, and provide means for energizing the process liquid with megasonic energy. Suitable transducers are sold by Verteq Inc. located in Santa Ana, Calif., and PCT Systems, Inc. located in Freemont, Calif. and has a number of individual piezoelectric elements mounted in a colinear elongated array with its major axis extending perpendicular to the plane of the figure. Megasonic energy is emitted as a collimated beam perpendicular to the face 32 of the process transducer 28. The lens 30 is generally semi-cylindrical in shape, with its axis oriented parallel to the transducer's major axis. The lens 30 acts to spread the collimated beam produced by the process transducer 28 into a uniform fan-shaped pattern in the plane of the figure as it rises through the process tank 12. The beam preferably widens quickly enough that the edges of the fan-shaped beam have reached the sides of the process tank 12 when the beam reaches a height above the process transducer 28 equal to the height of the bottom of the workpiece 14.

FIGS. 2-5 illustrate several variations on and additions to the basic apparatus. In FIG. 2, the process transducer 28 is mounted on the side of the process tank, with a curved reflector 34 located on the side of the process tank opposite the process transducer 28. The curved reflector 34 performs the function of spreading out the collimated beam from the process transducer 28 performed by the lens 30 in FIG. 1. The bottom edge 36 of the curved reflector 34 is preferably inclined to prevent trapping gas under the curved reflector 34. Still other means of generating megasonic energy can be used, such as the transducer with arcuate piezoelectric elements disclosed in the Olesen et al. reference. Optional means 38 for introducing a gas into the process liquid are used in certain embodiments of the method, as will be discussed later. The means can take the form of bubbling pipes, manifolds, molecular sieves, or other means known in the art. The gas introducing means can be used in other locations as desired.

FIGS. 3 and 4 respectively illustrate apparatus for using megasonic energy to propel particles in the liquid interface across the tank into the overflow tank 20. In FIG. 3 an overflow enhancement reflector 40 is positioned at the same height as the overflow weir 18 and angled to reflect energy from the process transducer 28 horizontally across the liquid interface in a manner similar to the main beam reflector 34 of FIG. 2. The overflow enhancement reflector 40 can be attached to the rack 16 or other means for holding the workpiece(s) so that the reflector 40 will not block the insertion and withdrawal of the rack from the process tank 12. In FIG. 4 an overflow enhancement transducer 42 (a smaller version of the process transducer 28) is used to generate sweeping megasonic waves directly. The overflow enhancement transducer 42 must be completely immersed during operation, so it is located slightly below the height of the overflow weir 18 and oriented with the emitted beam angled slightly upward from horizontal in order to strike the liquid interface. In both cases, the megasonic energy biases particles in the liquid interface toward the overflow weir 18.

The process transducer 28 and lens 30 can alternatively be located above the floor of the process tank as shown in FIG. 3. When this is done, a tunnel 44 must be formed through the tank 12 to allow wires (not shown) to be run to the transducer for providing power. The bottom edge 46 of the tunnel 44 is preferably shaped to prevent trapping gas below the tunnel and to minimize disturbing process liquid flow around the tunnel 44. An optional flow straightener 48 can also be used to prevent turbulence in the process liquid flow past the workpiece during filling. Optional drain connections 50 and 52 can be used when the process transducer 28 and lens 30 are mounted on the bottom 54 of the process tank, as the lens 30 can cause retention of process liquid.

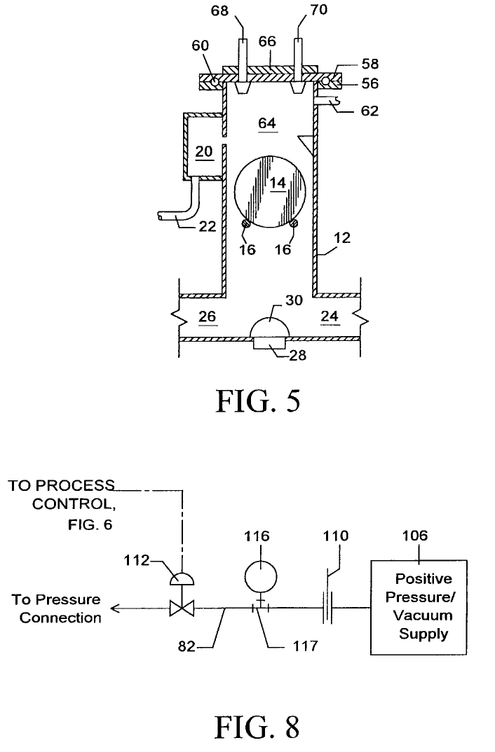

FIG. 5 shows an apparatus having a gas-tight process tank. The process tank 12 has a top flange 56 and hinged lid 58 that seal by use of an O ring 60, although other sealing means can be used. A pressure connection 62 on the side of the process tank provides means for connecting the interior 64 of the process tank to a source of vacuum or positive pressure as shown in FIG. 8. A second pressure connection 63 can also be used for venting and to allow purging the process tank interior 64, especially in combination with drying the workpiece. A venting scheme will preferably employ the same general equipment arrangement of FIG. 8 to balance the venting flow rate with the flow rate into the process tank from a positive pressure supply. Multiple pressure sources can be independently connected to the pressure connection 62 a manifold and block valves (not shown). The source of positive pressure or vacuum can be constant or controllably variable as required. The lid 48 is optionally heated by a conformal heated pad 66 or other means known in the art. Optional nozzles 68 and 70 add the capacity to inject mist or vapor into the process tank interior 64. Ultrasonic mist nozzles are preferred over simple mechanical mist nozzles for their wider discharge pattern and because they create smaller mist droplets that are more uniform in size.

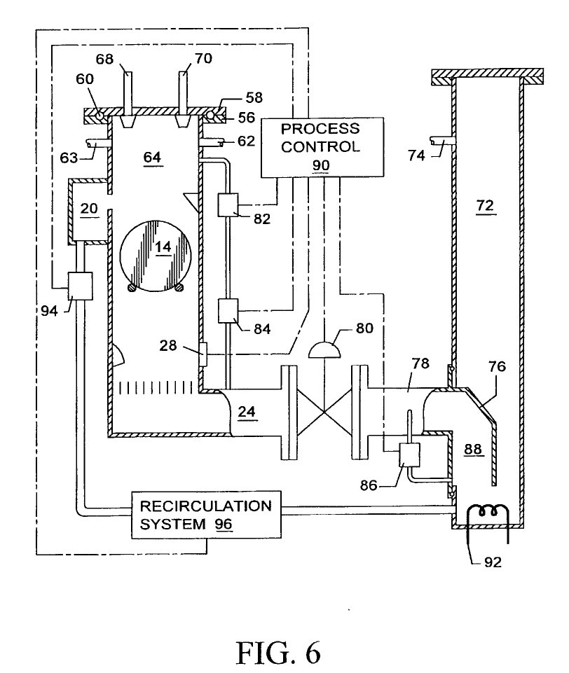

Turning to FIG. 6, a single-liquid system is shown with a process tank 12 and a home container 72 for holding the process liquid when not in use. While the process tank 12 and the home container are shown as separate vessels, a single vessel having internal baffling to create two separate compartments can also be used.

The process tank 12 and the home container 72 have pressure connections 62 and 74 respectively for varying the relative pressures in the two vessels, thereby biasing the process liquid to move into and out of the process tank 12. Preferably, varying the vessel pressures also provides the means for moving the energized liquid interface across the workpiece at a controlled rate. However, relative movement between the workpiece and the energized liquid interface can also be achieved by moving the workpiece(s), for example by mechanical means for raising and lowering the carrier rack 16. Particles in the liquid interface should be removed at least periodically by an overflow step even when the workpieces are moved instead of the liquid interface. The home container 72 is preferably sized to hold enough liquid to fill the process tank 12 to the overflow weir 18 and additional liquid as required for overflow and recirculation.

A downcomer 76 is located near the bottom of the home container 72 in series with the liquid external process connection 78, which connects to the process tank connection 24 through controllable means 80 for opening and closing the connection between the vessels. A butterfly valve is preferred for the closing means 80. Level switches 82, 84, and 86 are mounted on the process tank 12 and the downcomer section 88 of the home container 72 and detect when the liquid interface in the process tank 12 reaches predetermined heights and when the liquid level in the downcomer section 88 is below the bottom 54 of the process tank 12. These levels are useful in practicing the method of the invention, as will be discussed later. The level switches 82, 84, and 86 and the butterfly valve 80 connect to an automatic process control 90 which directs and controls the execution of the steps making up the method, especially the steps for moving the process liquid into and out of the process tank 12 and for moving the energized liquid interface relative to the workpiece at a controlled rate. The automatic process control 90 can have pneumatic, hydraulic, electronic, fluidic or digital signal processing elements or a combination of any of them. A heat transfer coil 92 in the bottom of the home container 72 maintains the process liquid temperature at a predetermined control point within a predetermined range. This control point can be varied as desired. Finally, overflow liquid from the overflow tank 20 passes through a block valve 94 to a recirculation system 96 where the overflow liquid can be filtered and processed before being sent back to the home container 72.

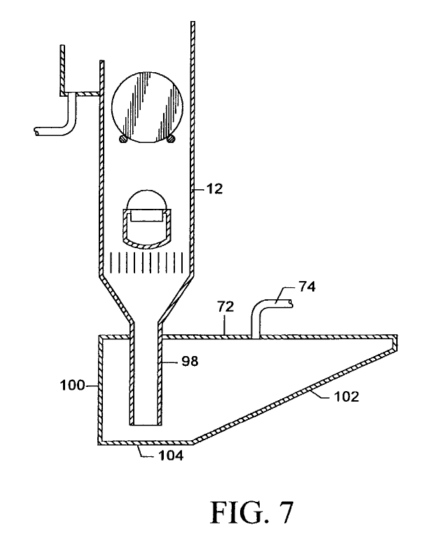

An alternative apparatus is disclosed in FIG. 7 for connecting the process tank 12 and the home container 72 when only a single process liquid is used. In this embodiment, a vertical riser 98 connects to the bottom of the process tank 12, replacing the butterfly valve 80 and downcomer 76 of FIG. 5. A pressure connection 74 on the home container 72 allows the use of varying positive pressure to drive process fluid into and out of the process tank 12 from the home container 72. As an alternative, the process tank 12 can be sealed and provided with a pressure connection 62 as shown in FIGS. 5 and 6, and vacuum and venting can be used in combination with positive pressure to move the process liquid back and forth, as previously described. The riser 98 is preferably located near one side wall 100 of the home container 72, with the opposite side wall 102 tapered toward the riser 98, so that the bottom 104 of the home container is only slightly wider than the riser 98. This configuration is use to minimize liquid inventory remaining in the home container after filling the process tank and providing additional liquid for overflow and recirculation. The opposite side wall 102 can be vertical if desired.

FIG. 8 shows a preferred apparatus for providing a supply of positive pressure or vacuum to the pressure connections 62 and 74. A supply 106 of positive pressure or vacuum connects to the process via a pressure line 108 in series with a restriction orifice 110 and an on/off control valve 112 (preferably operated by the process control 90 of FIG. 6). The pressure line 108 is sized for a flow rate many times the design flow rate of the restriction orifice 110. A pulse reservoir 116 is located on a tee connection 117 in the pressure line 108 between the restriction orifice 110 and the on/off control valve 112. The pressure reservoir 116 can be installed in-line if desired. When the on/off control valve 112 is opened, there will be a momentarily large gas flow between the pulse reservoir 116 and the process tank interior 54 which rapidly decrease as pressures in the process tank and the pressure reservoir equalize, after which flow reaches a substantially constant rate set by the restriction orifice 110. The flow pulse is used to compensate for system dynamics, permitting more rapid liquid level reversal in the process tank.

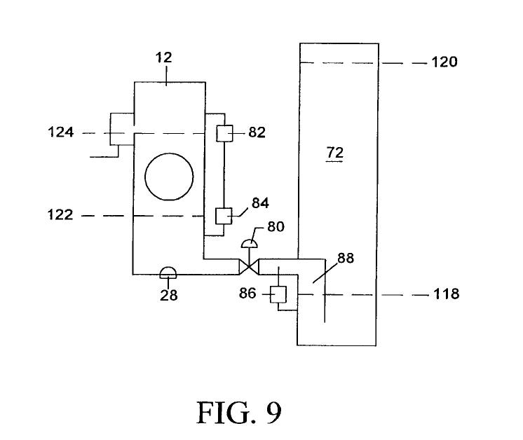

Levels in the vessels at various points in the general method of the invention are illustrated in FIG. 9, wherein only essential elements of the apparatus required to disclose the method are shown for the sake of clarity. While a system with gas-tight vessels is shown, it should be understood that one of the vessels can be open to the atmosphere.

Prior to practicing the method of the invention, the rack 16 with the workpieces 14 is placed into the process tank 12. At this time there is no process liquid in the process tank 12 and the butterfly valve 80 is closed. The liquid level in the downcomer 76 at this time is indicated by dashed line 118, corresponding to the trip point of the level switch 86, and the home container 12 is filled to the level indicated by dashed line 120. Once the workpieces 14 are in place, the butterfly valve 80 is opened and liquid will begin to flow from the home container 72 into the process tank 12. Positive pressure can be used in the home container 72, and either vacuum or venting can used in the process tank 12 to assist hydrostatic forces in filling the process tank. The liquid level eventually reaches the level indicated by dashed line 122 at a height between the process transducer 28 and the workpiece 14 which is the trip point for the lower level sensor 84. When a level is detected by the level sensor 84, power is applied to the process transducer 28.

In the next few steps, the megasonically energized liquid interface is swept back and forth across the surface of the workpiece at a controlled rate, preferably traversing the entire height of the workpiece. This can be achieved by moving the liquid interface or the workpiece or both. In the preferred embodiment, the liquid interface is moved alternately up and down while the workpiece remains in a constant position, in a manner similar to that disclosed in the '025 patent. The speeds and operating conditions disclosed in the Olesen et al. patent do not sweep the energized liquid interface at a controlled rate. The velocity of the liquid interface relative to the workpiece is preferably kept uniform so that each point on the workpiece is exposed to the energized liquid interface for the same amount of time. However, the rate of movement can be varied for workpieces having nonuniform shape or varying levels of contamination (i.e. especially dirty areas), which is important in some areas outside of semiconductor manufacturing.

The liquid continues to rise in the process tank 12 at a controlled rate after the process transducer is energized until it reaches the level indicated by dashed line 124. This level is the trip point for the upper level sensor 82, and is substantially at the height of the overflow weir 18, so that process liquid begins to flow past the overflow weir into the overflow tank 20 at or near the same time that the level sensor switches. At this point, the process is reversed, and the liquid level is lowered at a controlled rate back down to the level indicated by dashed line 122. If desired, the liquid level can be held momentarily at the level indicated by dashed line 124, and megasonic energy can optionally be applied across the liquid interface to propel particles into the overflow tank using one of the means shown in FIGS. 3 and 4.

A sweep cycle is made up of two sweeps, one up and one down, of the liquid interface between the levels indicated by dashed lines 122 and 124. The number of sweep cycles required to remove film and particles from the workpiece down to a desired particle count will be different for different uses. In semiconductor wafer and photomask processing, five sweep cycles will reduce the particle count on the wafer surface to zero. This particle count remains constant with additional sweep cycles, i.e. particles do not tend to redeposit back onto the wafer.

Preferably, level sensing is used to determine when to change direction of the movement of the energized interface. Other means for determining when to alternate direction can be used however, especially sensing the beginning of overflow. Numerous means for detecting overflow are available.

To end the last sweep cycle, the liquid interface is lowered to about the level indicated by dashed line 122. This step can be carried out at a slower rate than the rest of the sweep steps to ensure proper drying. Power is then shut off from the process transducer 28 and the process liquid is moved back into the home container until the liquid level reaches the level indicated by dashed line 118, at which time the butterfly valve 80 is closed and the process ends. The processed workpieces can now be removed from the apparatus, and another batch of workpieces placed in the process tank. Power for the process transducer 28 can be shut off based directly on the signal from the lower level sensor 84 or by inferring when the level reaches the height indicated by dashed line 122. A preferred inferential method is to keep the rate at which the liquid level falls constant, then shut off the power after the time required to lower the liquid interface to the level indicated by dashed line 122. Other direct and inferential means known in the process control field can also be used.

As already discussed with regard to the Olesen et al. reference, spraying the workpiece and the interior of the process tank creates several means for contaminating the workpiece, and is unnecessary when the present method is used. Therefore, the final sweep step is carried out without the use of spray. Preferably, spray is not used at any point in the present method.

Up to this point, the detailed discussion has been limited to the use of the megasonically energized liquid interface for removal of film and particles from a workpiece surface. However, the literature indicates that megasonic energy is useful for promoting physical and chemical phenomena by increasing the rate at which reagents are brought to the reaction site and the rate of removal of products from the reaction site. Therefore, it is expected that the energized liquid interface will be beneficial in such uses, and that the same benefits over continuous immersion (e.g. increased reaction rate, more uniform reaction rate across the workpiece surface) will be obtained. A partial list of potential uses includes electroplating, electroless plating, and controlled formation of native oxide on semiconductor wafers. Some of these potential uses are intended to be the subject of future patents by the inventor.

Several examples will now be discussed to illustrate and confirm the features and advantages of the invention.

EXAMPLE 1: A megasonic cleaning tank made by Bold Technologies was filled with dilute Standard-Clean 1 (SC-1) at 30° C. The tank uses a megasonic transducer operating at 300 watts total power (about 25 watts per inch of piezoelectric element) and about 850 kilohertz. A photomask was treated by raising and lowering the photomask through the energized liquid interface for five cycles, each cycle consisting of a down-and-up pair of sweeps (ten total sweeps) with every sweep being three seconds long. All particles on the photomask 0.25 microns and larger were mapped before and after treatment. Post-treatment testing indicated zero particles remaining.

EXAMPLE 2: the test procedure of Example 1 was repeated using a total of ten cycles. Again, post-treatment testing indicated zero particles remaining.

EXAMPLE 3: the test procedures of Example 1 and Example 2 were repeated using equal up and down sweep times of one second duration, for a total particle removal time of only ten seconds and twenty seconds, respectively. Once again, post-treatment testing indicated zero particles remaining.

EXAMPLE 4: the test procedure of Example 1 was repeated, but only two cycles were performed (four total sweeps) of equal one second duration. Post-treatment testing showed particles remaining, with substantially uniform percentage reduction in particle count across the photomask surface.

The example results are critically important for photomask production. The photomask pattern is printed on every die on a semiconductor wafer. Even a single defect on a photomask could kill every die on the wafer. The examples show that the method of the invention can produce photomasks with zero particles remaining, and do so consistently. The invention is also suitable for semiconductor wafer processing.

The method and apparatus of the invention have several advantages over the prior art. The apparatus is less expensive to construct and has fewer parts to assemble than other devices designed to meet the requirements of present and imminent cleaning standards in semiconductor manufacture, and yet removes more particles, and particles of smaller size, than is possible with any other known method. It has no complicated moving parts, and can be easily installed.

The invention has been shown in several embodiments. It should be apparent to those skilled in the art that the invention is not limited to these embodiments, but is capable of being varied and modified without departing from the scope of the invention as set out in the attached claims.

1. An apparatus for removing material adhering to a workpiece using the interface of a process liquid and an adjacent discontinuous phase comprising: a process tank having an interior designed to receive at least one workpiece, the process liquid, and the discontinuous phase; means for energizing the interface with megasonic energy; and means for producing relative movement between the interface and the workpiece at a controlled rate when the interface contacts the workpiece.

2. An apparatus as recited in claim 1, wherein the means for producing relative movement between the interface and the workpiece is also a means for moving the process liquid into and out of the interior of the process tank.

3. An apparatus as recited in claim 1, further comprising automatic process control means connected to the means for energizing the interface and the means for producing relative movement.

4. An apparatus as recited in claim 1, further comprising means for forming a gas-tight seal about the interior of the process tank, and means for varying the pressure at the interior of the process tank.

5. An apparatus as recited in claim 2, further comprising means for independently moving a plurality of process liquids into and out of the interior of the process tank.

6. An apparatus as recited in claim 1, further comprising means for removing a portion of the process liquid from the process tank as an overflow liquid.

7. An apparatus as recited in claim 6, further comprising a home container connected to the process tank and means for recirculating the overflow liquid to the home container.

8. An apparatus as recited in claim 1, further comprising means for maintaining the process liquid temperature at a predetermined value.

9. An apparatus as recited in claim 6, wherein the process liquid contains entrained particles, further comprising means for using megasonic energy to propel the entrained particles into the overflow liquid.

10. An apparatus as recited in claim 2, further comprising means for introducing a gas into the process liquid for absorption into the process liquid.

11. An apparatus for removing material adhering to a workpiece using the interface of a process liquid and an adjacent discontinuous phase comprising: a process tank having an interior designed to receive at least one workpiece, the process liquid, and the discontinuous phase; means for energizing the interface with megasonic energy; and means for producing relative linear movement between the interface and the workpiece in alternating directions at a controlled rate.

12. An apparatus as recited in claim 11, further comprising means for forming a gas-tight seal about the interior of the process tank, wherein the means for producing relative movement between the interface and the workpiece further comprises a home container connected to the process tank, pressure-varying equipment connected to one or both of the process tank and the home container, level switches attached to the process tank and the home container, and an automatic process control connected to the level switches, the equipment for varying pressure in the home container or the process vessel and the means for energizing the interface.

13. An apparatus as recited in claim 11, further comprising means for forming a gas-tight seal about the interior of the process tank, wherein the means for producing relative movement between the interface and the workpiece further comprises a home container connected to the process tank, pressure-varying equipment connected to one or both of the process tank and the home container, means for determining when to alternate direction of relative movement, and an automatic process control connected to the pressure-varying equipment, the means for energizing the interface and the means for determining when to alternate direction of relative movement.

14. An apparatus as recited in claim 12, further comprising a plurality of process liquids, each process liquid having a home container connected to the process tank, and means for dependently moving each of the process liquids from its home container into and out of the process tank.

15. An apparatus as recited in claim 11, further comprising means for removing a portion of the process liquid from the process tank as an overflow liquid.

16. An apparatus as recited in claim 15, further comprising a home container connected to the process tank and means for recirculating the overflow liquid to the home container.

17. An apparatus as recited in claim 11, further comprising means for maintaining the process liquid temperature at a predetermined value.

18. An apparatus as recited in claim 15, wherein the process liquid contains entrained particles, further comprising means for using megasonic energy to propel the entrained particles into the overflow liquid.

19. An apparatus as recited in claim 11, further comprising means for introducing a gas into the process liquid for absorption into the process liquid.

20. A method for removing material adhering to a workpiece, comprising the steps of: A) creating an interface between a process liquid and a discontinuous phase; B) energizing the interface with megasonic energy; C) contacting the workpiece with the energized interface and moving the energized interface relative to the workpiece at a controlled rate; and D) repeating step (C) a predetermined number of times, alternating the direction of relative movement with each repetition of step (C).

21. The method recited in claim 20, wherein the workpiece does not move during steps (C) and (D).

22. The method recited in claim 21, and wherein the interface remains fully energized between successive sweeps.

23. The method recited in claim 20, wherein the workpiece is completely separated from the process liquid after the final repetition of step (C).

24. The method recited in claim 23, further comprising the step of drying the workpiece concurrently with or immediately following the final repetition of step (C).

25. The method recited in claim 24, wherein the process liquid is deionized water or dilute SC-1 at a temperature between 30 and 90 degrees Celsius, and the drying step comprises exposing the workpiece to a purge gas until the process liquid evaporates from the workpiece.

26. The method recited in claim 24, wherein the drying step further comprises condensing a vaporized second chemical on the workpiece and in the liquid interface, and mixing the second chemical with the process liquid in the liquid interface during separation of the workpiece from the process liquid.

27. The method recited in claim 24, wherein the drying step further comprises wetting a misted second chemical on the workpiece and in the liquid interface, and mixing the second chemical with the process liquid in the liquid interface during separation of the workpiece from the process liquid.

28. The method recited in claim 24, wherein process liquid is at a temperature slightly above its freezing point and initially at a pressure above its sublimation point, and the discontinuous phase is at a temperature below the freezing point of the process liquid, the drying step further comprising freezing the process liquid onto the workpiece as it is withdrawn from the process liquid, followed by removing the remaining process liquid and lowering the pressure of the discontinuous phase to sublime the frozen process liquid.

29. The method recited in claim 24, further comprising introducing a gas into the process liquid during step (D) for reducing the formation of droplets on the workpiece during the drying step.

30. A method for removing material adhering to a workpiece, comprising the steps of: A) creating an interface between a process liquid and a discontinuous phase; B) energizing the interface with megasonic energy; C) contacting the workpiece with the energized interface and moving the energized interface relative to the workpiece at a controlled rate; and D) repeating step (C) a predetermined number of times, alternating the direction of relative movement with each repetition of step (C); wherein step (D) is performed without spraying the workpiece.

31. A method as recited in claim 30, wherein both step (C) and step (D) are performed without spraying the workpiece.
